(19) United States
(12) Patent Application Publication
(10) Pub. No.: US 2005/0008739 A1
(43) Pub. Date: Jan. 13, 2005

(54) Method and assembly for pasteurizing and homogenizing low viscosity liquids

(75) Inventors: Kushal K. Talukdar, Weyland, MA (US); William M. Pozzo, No. Easton, MA (US); Thomas J. Baldasarre, Mansfield, MA (US); George E. Anderson, Barrington, RI (US)

Correspondence Address: Scott R. Foster;Pandiscio & Pandiscio, P.C., 470 Totten Pond Road, Waltham, MA, 02451-1914, US

(73) Assignee: Harris Acoustic Products Corp.

(21) Appl. No.: 10/915,228

(22) Filed: Aug. 10, 2004

Related U.S. Application Data
(63) Continuation-in-part of application No. 10/383,197, filed on Mar. 6, 2003.
(60) Provisional application No. 60/364,014, filed on Mar. 13, 2002.
(60) Provisional application No. 60/554,060, filed on Mar. 16, 2004.

(51) Int. Cl. A23L 3/00

(52) U.S. Cl. 426/238

(57) ABSTRACT

A method and assembly for pasteurizing and homogenizing low-viscosity liquids, the method including the steps of flowing the liquid through a tube comprising a transducer for converting electrical energy to acoustic energy, and providing electrical power to the transducer to generate ultrasound and to transmit the ultrasound through the liquid in the tube to induce acoustic cavitation in the liquid in the tube, wherein the cavitation so induced operates to inactivate microorganisms in the liquid and to reduce the size of fat globules in the liquid to a point at which the globules refrain from coalescing and rising to the surface of the liquid during the useful storage life of the liquid.

### CROSS-REFERENCE TO RELATED APPLICATIONS

This application is a continuation-in-part of U.S. patent application Ser. No. 10/383,197, filed Mar. 6, 2003 in the names of Robert F. Carlson, Thomas J. Baldasarre, Kushal K. Talukdar, George E. Anderson and William M. Pozzo, which in turn claimed the benefit of U.S. Provisional patent Application No. 60/364,014, filed Mar. 13, 2002 in the names of Robert F. Carlson, Thomas J. Baldasarre, and Kushal K. Talukdar.

This application further claims the benefit of U.S. Provisional Patent Application Ser. No. 60/554,060, filed Mar. 16, 2004, in the name of Kushal K. Talukdar.

The above prior applications are incorporated herein by reference.

### BACKGROUND OF THE INVENTION

1. Field of the Invention

The invention relates to the purification of low viscosity liquids and is directed more particularly to the pasteurization and homogenization of milk and other such low viscosity liquids.

2. Description of the Prior Art

Milk is a widely consumed natural liquid food, containing high quality protein and many essential vitamins and minerals. For thousands of years humans have consumed milk in many ways, including drinking it and churning it to produce butter or other cultured products, such as cheese or buttermilk. Milk is also combined with other ingredients to make foods such as ice cream, baked goods, and candies.

Depending upon the environment, milk, like many other foods, contains various bacteria. In general, bacteria can be classified into one of three categories, namely, beneficial, spoilage, and pathogenic. While beneficial bacteria help to produce cheese, yogurt etc., spoilage bacteria cause the food to smell foul, taste bad, etc. Pathogenic bacteria can make people or animals ill. Although most of the bacteria in milk from healthy animals are harmless, pathogenic bacteria can be introduced to the milk from a number of sources. A change in the health of the animals, or cuts and wounds in the animals, pollutants in the water, dirt, manure, and the like, can introduce pathogenic bacteria into milk, which can cause widespread outbreaks of diseases in the population. During the 19th and 20th centuries, milk was responsible for a large portion of the substantial infant mortality rate, which was 20% or higher in many United States and European cities. The list of diseases at that time associated with milk includes tuberculosis, typhoid fever, scarlet fever, septic sore throat, gastroenteritis, scarlet fever, cow pox, diphtheria and Malta fever.

Pasteurization by heat treatment currently is a most important aspect of processing milk. Inasmuch as bacteria inactivation is a function of temperature, there are different holding times for pasteurizing milk at different temperatures. Typically, the milk is considered pasteurized if the temperature is maintained at 63° C. for 30 minutes. If the temperature is raised to 72° C. the holding time required for pasteurization drops to 16 seconds. State and local governments, following Food and Drug Administration guidelines, firmly enforce strict regulations on milk for sale. By law, milk shipped interstate must be pasteurized.

Primarily, there are two commercial techniques for pasteurization, namely, batch and continuous. In batch pasteurization, milk is heated in a vat. The vat is heated either by circulating water or steam around the vat. During the pasteurization, an agitator stirs the milk continuously to provide for uniform heating. This method finds very little use for processing regular milk, but is used in production of other milk-based products, such as ice cream.

The continuous process offers time and energy savings by flowing the milk continuously through a set of plates. The most common continuous processing is known as “High Temperature Short Time” pasteurizing. The heating is provided by a plate heat exchanger, consisting of a stack of stainless steel plates held together in a frame. Once again, the heat source can be steam or hot water.

Besides public safety, another important aspect of pasteurization is that of increasing the shelf life of the treated product. Since pasteurization destroys spoilage bacteria and some undesirable enzymes, the product can be used even after being sixteen days on store shelves. In order to increase the shelf life further, a more extreme treatment called Ultra High Temperature (UHT) is sometimes performed. In UHT pasteurization, the temperature of the milk is raised to about 141° C. for one or two seconds, sterilizing the milk completely.

While the benefits of pasteurization cannot be over emphasized, heat treatment does affect the flavor properties of some of the milk-derived products, such as cheese. Some countries in Europe use un-pasteurized milk for producing flavorful cheese. In some states in the United States farmers are taking advantage of a recent law allowing the sale of un-pasteurized milk, deemed to be more flavorful. To discourage spreading of such sales, with consequent risks, it would be helpful if milk could be pasteurized at a lower temperature, which would preserve the flavor, in addition to making pasteurization cheaper and increasing shelf life.

Milk is essentially and oil-in-water emulsion, in which fat globules are distributed within skim-milk. When raw milk is left alone, over time the fat rises and forms a cream layer. The homogenization process reduces the size of the fat globules in milk to such an extent (<1 micron in diameter) that the globules do not coalesce and rise to the surface of milk during the useful storage life of the milk. This is accomplished by passing milk under high pressure through tiny orifices or homogenization valves, which results in a decrease in the average diameter, and an increase in number of, and surface area of, fat globules. Homogenization also coats the smaller globules with casein protein, which aids in preventing the globules from subsequently coalescing.

Three factors contribute to enhanced stability of homogenized milk: a decrease in the mean diameter of the fat globules, a decrease in the size distribution of the fat globules (causing the speed of rise to be similar for the majority of globules such that they don't tend to cluster during creaming), and an increase in density of the globules (bringing them closer to the continuous phase) due to the absorption of a protein membrane. In addition, heat pasteurization breaks down the cryo-globulin complex, which otherwise tends to cluster fat globules, causing them to rise.

It is most likely that turbulence and cavitation cause the reduction in size of the fat globules during the homogenization process. The turbulent eddies, generated by the energy dissipated in the liquid going through the tiny orifices of homogenizer valves, tear apart the fat globules and reduce their average size. Further, since the pressure drops considerably with a change in the velocity of the fluid, the liquid cavitates when the vapor pressure is attained. The cavitation generates further eddies that disrupt the fat globules.

As the cost of milk production has increased over the years (farm labor, farm machinery, animal feed, etc.) very little of the retail price increase has trickled down to farmers to offset the costs. The rising costs have driven many small dairy farmers out of business. The number of dairy firms has dropped nationwide by over 40,000 licensed dairies since 1992, and the trend is to merge dairy farms into bigger entities in order to achieve economies of scale. However, small local dairy farms not only ensure an adequate and low cost supply of milk in the local markets, but also provide cultural and economic benefits to the community.

Most farmers (about 83%) sell their milk to dairy cooperatives that are owned and financed by farmer members. Some of the reasons for joining the cooperatives are to get bargaining power and obtain the best market price, effective representation in legislature and regulatory matters, and the like. The cooperatives usually sell the unprocessed milk to wholesale milk processors. The wholesalers provide a number of services, such as pasteurization, homogenization, packaging the products and arranging for the distribution of the products to retail outlets. Retailers, such as supermarkets and convenience stores, are responsible for advertising, providing shelf space and selling the milk to consumers.

According to a study at Cornell University, the total cost (in 1995) to sell a gallon of 2% milk in a New York supermarket was about $2.12. Depending on the distance between the milk processing plants and the points of consumption, more than 50 cents in costs can be added to the price of milk. For example, it is estimated that $0.67 is the transportation cost for a gallon of milk delivered to Massachusetts from the Wisconsin dairy lands.

Other factors that can add to the costs are marketing advertisements, packaging, and other incidental costs.

It appears that farmers could obtain a better price if they could sell their products in local markets, requiring that they be capable of processing their products in a cost effective way. Two fundamental components of processing milk are pasteurization for pathogen neutralization and homogenization for longer and improved appearance of milk. For public health reasons, almost all state and local agencies related to milk, enforce pasteurization. Typically, such operations are carried out at the wholesale level, in large plants capable of processing 1,000 to 45,000 gallons of milk per hour. Such capacities, and the large capital requirement, act as a barrier to small farmers.

It would be beneficial to the dairy farmer and to the consuming public to provide small dairy farmers with means for pasteurization and homogenization in a cost effective way. Such would permit small dairies to compete effectively, be healthy participants in local economies, and offer more choices to consumers. Accordingly, there is a need for a pasteurization and homogenization method and assembly which would facilitate the effective but inexpensive pasteurization and homogenization of milk by small dairies.

### SUMMARY OF THE INVENTION

An object of the invention is accordingly to provide a low-cost method and assembly for pasteurization and homogenization of milk and other low viscosity liquids, such as juices, soft drinks, and the like.

A further object of the invention is to provide such a method and assembly as is readily adaptable and implementable in operations of various sizes and capacities.

A still further object of the invention is to provide such a method and assembly which combines pasteurization and homogenization into a single operation.

With the above and other objects in view, a feature of the present invention is the provision of a method for pasteurizing and homogenizing low-viscosity liquids, such as milk. The method includes the steps of flowing the liquid through a tube comprising a transducer for. converting electrical energy to acoustic energy, and providing electrical power to the transducer to generate ultrasound and to transmit the ultrasound through the liquid in the tube to induce acoustic cavitation in the liquid in the tube. The cavitation so induced operates to inactivate microorganisms in the liquid and to reduce the size of fat globules in the liquid to a point (less than one micron in diameter) at which the globules refrain from coalescing and rising to the surface of the liquid during the useful storage life of the liquid.

In accordance with a further feature of the invention, there is provided a cavitation assembly for simultaneous pasteurization and homogenization of milk and other low-viscosity liquids. The assembly comprises a generally cylindrically-shaped open-ended tube for flow of milk or other liquids therethrough, the tube comprising a transducer for converting electrical energy to acoustic energy and transmitting ultrasound through the milk or other liquid in the tube to induce cavitation in the milk or other liquid in the tube. A liquid moving means is provided for flowing the milk or other liquid through the tube, and an electrical power source is provided for providing electrical power to the tube. The cavitation induced in the milk or other liquid inactivates microorganisms in, and reduces the size of fat globules in, the milk or other liquid to a point at which the globules refrain from coalescing and rising to the surface during a useful storage life of the milk or other liquid.

The above and other features of the invention, including various novel details of construction, method steps, and combinations of parts, will now be more particularly described with reference to the accompanying drawings and pointed out in the claims. It will be understood that the particular method embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

Reference is made to the accompanying drawings in which are shown illustrative embodiments of the invention, from which its novel features and advantages will be apparent.

In the drawings:

FIGS. 1A and 1B are diagrammatic flow charts illustrating a method and use of an assembly or assemblies singly and in groups;

FIG. 2 is a partly sectional view of a transducer portion of one form of an assembly illustrative of an embodiment of the invention; and

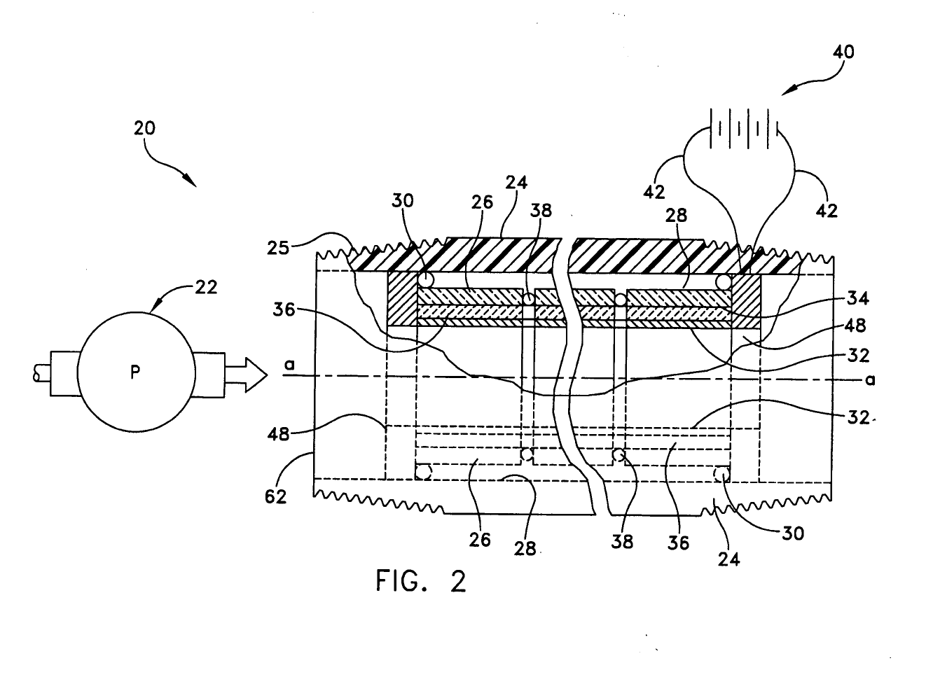

FIG. 3 is a perspective view of a portion of the assembly of FIG. 2.

### DESCRIPTION OF THE PREFERRED EMBODIMENTS

Cavitation is the phenomenon of creation and implosion of microscopic bubbles in a liquid and is caused by the rapid changes in the liquid pressure. A mechanism for inducing rapid change in pressure is the transmission of ultrasound through the liquid. The sound can be created either by a piezoelectric or magnetostrictive transducer. Coupling a sound transducer to the liquid medium and driving the transducer with sufficient power creates an alternating pressure cycle that induces cavitation.

The parameters that affect cavitation are input energy transmitted in the medium, frequency of sound, number of sound pulses, and the ambient pressure of the liquid. Typically, the higher the frequency, the greater is the cavitation threshold, and the smaller the bubble size. There are three distinct stages associated with cavitation.

1. Nucleation—The cavitation bubbles are formed in this stage.

2. Bubble growth—The bubbles grow in this stage by absorbing the energy from the alternating compression and expansion caused by ultrasound.

3. Implosion—In this stage the growing bubble reaches a critical size and implodes.

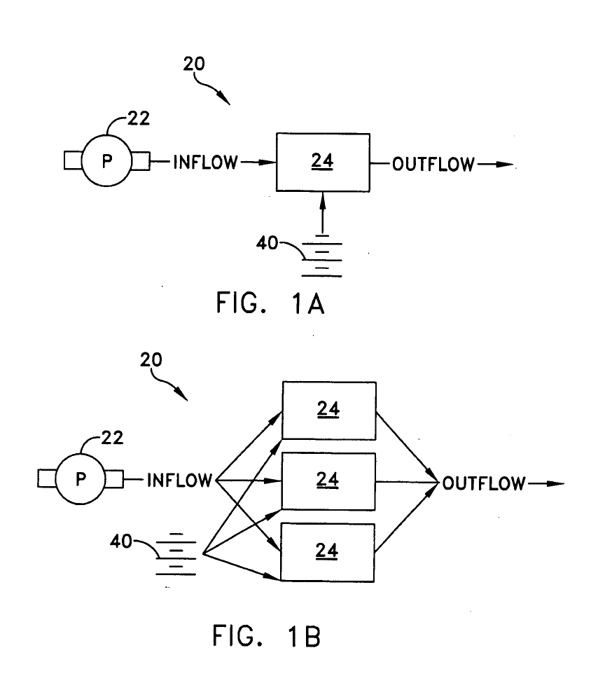

For pasteurization and homogenization of milk and other low-viscosity liquids, piezoelectric ceramic ring transducers are ideally suited for their ability to focus sound resulting in an efficient cavitation system. As shown in FIG. 1, such transducers can be readily adapted to piping systems for individual small farm usage and can be scaled up by parallel connections for larger farms and/or dairy cooperatives to meet the demands of the facility. Once an individual acoustic cavitation chamber is provided for an appropriate flow rate, a multiplicity of like cavitation chambers can be combined to provide the necessary flow rate for larger or growing installations.

An illustrative liquid acoustic cavitation assembly 20 includes a liquid moving means, such as a pump 22, for providing a suitable flow rate for a particular site. The assembly 20 further includes a generally cylindrically-shaped open-ended tubular housing 24 for flow of liquid therethrough. The housing 24 may be of metal, PVC, or a composite. It may be provided with threads 25, internal or external, or quick-connect and disconnect connectors (not shown) for insertion and ready removal from a liquid conduit. An annularly-shaped fiberglass wrap 26 is disposed coaxially in the housing 24 and is spaced from the housing to form an annular chamber 28. O-rings 30 are disposed in the chamber 28 and abut the housing 24 and the fiberglass wrap 26 and serve to seal the chamber 28 against migration of liquid thereinto.

A cylindrically-shaped non-toxic open ended tube 32 is disposed coaxially in the fiberglass wrap 26 and is spaced inwardly therefrom. The non-toxic tube 32 preferably is of a metal or composite material The non-toxic tube 32 and the fiberglass layer 26 define an annular space 34 in which are disposed ceramic rings 36. In manufacture, the fiberglass wrap 26 is applied to the outer surface of the ceramic rings 36, to pre-stress the ceramic rings, as is known in the art. The ceramic rings 36 are separated by isolation rings 38.

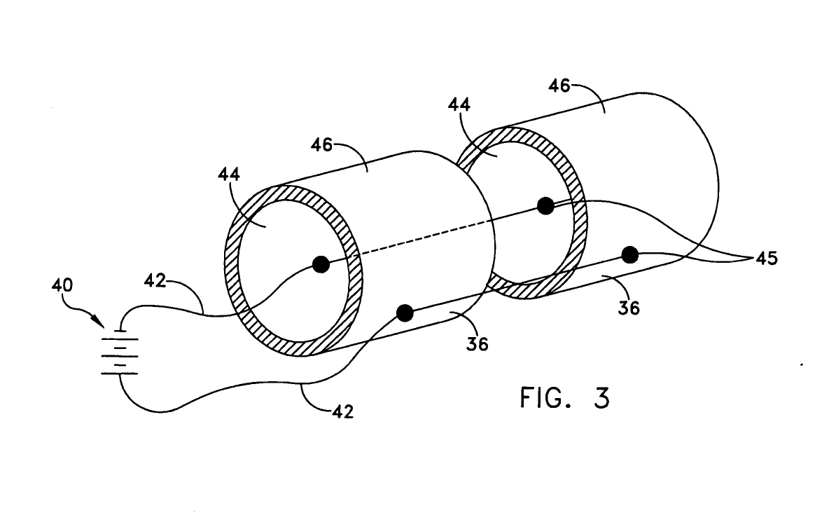

The assembly 20 includes a power source 40 which provides power through electrically conductive lines 42 to inside and outside surfaces 44, 46 (FIG. 3) of the ceramic rings 36. The surfaces 44, 46 are coated with silver plate and the wires 42 are soldered to the silver plate, as at points 45. The ceramic rings 36 are driven in parallel. Power is applied by way of an alternating voltage operating close to the natural frequency of the ceramic rings 36 to achieve maximum vibration, and hence, maximum cavitation.

The ceramic rings 36 are selected to match a targeted frequency within a range of ultrasonic frequencies of about 20-200 kHz. Ideally, the cavitation field should be uniform within the tube 32 so that any micro-organism passing through the tube will experience the same dose of cavitation. However, the ceramic geometries and the superposition of different frequencies may alter the distribution. Since cavitation is associated with bubble formation, and collapsing bubbles produce sound, locations with higher bubble concentrations may exhibit higher local sound levels. The ceramic rings 36 may contain ceramics of different frequencies, wherein each ring vibrates at a different frequency.

The ends of the annular chamber 28 and the annular space 34 are closed by epoxy ribs 48.

A preferred embodiment of the assembly 20 includes a 1.5 inch OD×2.0 inch long ring assembly of piezoelectric ceramic encased within a PVC tubular housing 24, with inlet and outlet threads 25 or other connections for hose attachments for liquid flow.

In use of the assembly 20, milk or other low viscosity liquid is flowed through the cylindrically-shaped non-toxic tube 32 disposed within the ceramic rings 36 which, in turn, are wrapped with the fiberglass 26, all disposed within the generally cylindrically-shaped open-ended tubular housing 24. The liquid is flowed typically by a pump 22.

Such assemblies may be used as acoustic cavitation devices for pasteurization and homogenization of low viscosity liquids, including milk. The tubular housings 24 can be plumbed to existing flow pipes and activated only when liquid flow is detected. The advantages of such an acoustic cavitation purifier are two-fold: (1) it accomplishes both pasteurization and homogenization simultaneously, and (2) it can be scaled up to serve the needs of a larger operations. The projected costs of such individual cavitation assemblies is quite low, typically less than $100 (U.S.) per cavitation assembly.

The pasteurization and homogenization, in turn, provide the benefits of (1) inactivating spoilage and pathogenic bacteria, thereby rendering the liquid safe to drink, (2) increasing shelf life of the liquid, and (3) improving flavor of the liquid, particularly with respect to milk. The cost efficiency of the method of simultaneous pasteurization and homogenization renders possible the benefits of local sales by local dairies, reduction in costs of delivering of the liquid to retail outlets, and benefits to the local community.

It will be understood that many additional changes in the details, materials, method steps and arrangement of parts, which have been herein described and illustrated in order to explain the nature of the invention, may be made by those skilled in the art within the principles and scope of the invention as expressed in the appended claims.

1. A method for pasteurizing and homogenizing low-viscosity liquids, the method comprising the steps of:
flowing the liquid through a tube comprising a transducer for converting electrical energy to acoustic energy; and
providing electrical power to the transducer to generate ultrasound and to transmit the ultrasound through the liquid in the tube to induce acoustic cavitation in the liquid in the tube;
wherein the cavitation so induced operates to inactivate microorganisms in the liquid and to reduce the size of fat globules in the liquid to a point at which the globules refrain from coalescing and rising to the surface of the liquid during a useful storage life of the liquid.

2. A method for pasteurizing and homogenizing milk, the method comprising the steps of:
flowing the milk through a generally cylindrically-shaped open-ended tube comprising a transducer for converting electrical energy to acoustic energy; and
providing electrical power to the transducer to generate ultrasound and transmit the ultrasound through the milk in the tube to induce cavitation in the milk in the tube;
wherein the cavitation so induced operates to inactivate microorganisms in the milk and to reduce the size of fat globules in the milk to a point at which the globules refrain from coalescing and rising to the surface of the milk during a useful storage life of the milk.

3. A method for simultaneously pasteurizing and homogenizing milk, the method comprising the steps of:
flowing the milk through a generally cylindrically-shaped open-ended non-toxic tube having ceramic rings mounted thereon; and
providing electrical power to the ceramic rings to generate ultrasound, and transmitting the ultrasound through the milk in the tube to induce cavitation in the milk in the tube;
whereby to inactivate microorganisms in the milk and to reduce the size of fat globules in the milk to a point at which the globules refrain from coalescing and rising to the surface of the milk during a useful storage life of the milk.

4. A method for pasteurizing and homogenizing drinking liquids, the method comprising the steps of:
flowing the liquid through a generally cylindrically-shaped open-ended tubular housing having an annularly-shaped fiberglass layer disposed coaxially therein and spaced from the housing, and having ceramic rings disposed adjacent the fiberglass layer and disposed inwardly thereof; and
providing electrical power to the ceramic rings to vibrate the rings to generate ultrasound, and transmitting the ultrasound through the liquid to induce cavitation in the liquid in the housing;
wherein the cavitation in the liquid serves to inactivate microorganisms in the liquid and to reduce the size of fat globules in the liquid to a point at which the globules refrain from coalescing and rising to the surface of the liquid during a useful storage life of the liquid.

5. The method in accordance with claim 3 wherein the electrical power provided to the transducer is of an alternating voltage operating close to a natural frequency of the ceramic rings.

6. The method in accordance with claim 3 wherein the size of the fat globules is reduced to less than one micron in diameter.

7. The method in accordance with claim 6 wherein the globules of reduced size are coated by the homogenization with casein protein to assist in preventing subsequent coalescing of the reduced globules.

8. The method in accordance with claim 3 wherein the transmission of ultrasound through the milk in the tube produces a substantially uniform cavitation field within the tube.

9. A method for simultaneously pasteurizing and homogenizing milk without subjecting the milk to heat treatment, whereby to render the milk safe to drink, of substantially uniform composition, of extended shelf life, and without substantial loss of flavor, the method comprising the steps of:
flowing the milk through a tube comprising a transducer for converting electrical energy to acoustic energy; and
providing electrical power to the transducer to generate ultrasound through the milk in the tube to induce cavitation in the milk in the tube.

10. A cavitation assembly for simultaneous pasteurization and homogenization of milk, the assembly comprising:
a generally cylindrically-shaped open-ended tube for flow of milk therethrough, said tube comprising a transducer for converting electrical energy to acoustic energy and transmitting ultrasound through the milk in the tube to induce cavitation in the milk in the tube;
a milk moving means for flowing the milk through said tube; and
an electrical power source for providing electrical power to said tube;
wherein the cavitation inactivates microorganisms in the milk; and
wherein the cavitation reduces the size of fat globules in the milk to a point at which the globules refrain from coalescing and rising to the surface of the milk during a useful storage life of the milk.

11. The assembly in accordance with claim 10 wherein said tube includes rings of ceramic material.

12. The assembly in accordance with claim 11 wherein said tube and ceramic rings comprise a piezoelectric transducer.

13. The assembly in accordance with claim 12 wherein said transducer is adapted to operate at ultrasonic frequencies of about 30-200 kHz.

14. The assembly in accordance with claim 13 wherein said rings are of different ceramic materials and adapted to operate at different ones of the frequencies.

15. A cavitation assembly for simultaneous pasteurization and homogenization of milk, the assembly comprising:
a generally cylindrically-shaped open-ended tubular housing for flow of milk therethrough;
an annularly-shaped fiberglass layer disposed coaxially in said housing and spaced from said housing;
a cylindrically-shaped non-toxic open-ended tube disposed coaxially in said fiberglass layer and spaced from said fiberglass layer, and defining an internal passageway for the flow of milk;
ceramic rings disposed between said fiberglass layer and said non-toxic tube;
isolation rings disposed between adjacent ones of said ceramic rings; and
an electrical power source for electrical excitation of said ceramic rings for effecting cavitation of milk in said assembly.

16. The cavitation assembly in accordance with claim 15 wherein said non-toxic tube is of a selected one of metal and composite material.

17. The cavitation assembly in accordance with claim 15 and further comprising means for flowing milk through the assembly.

18. The cavitation assembly in accordance with claim 15 wherein said tubular housing is of a selected one of metal, PVC, and composite materials.

19. A cavitation assembly for simultaneous pasteurization and homogenization of milk without subjecting the milk to heat treatment, the assembly comprising:
a tubular housing for flow of milk therethrough;
a fiberglass tube disposed coaxially in said housing and spaced from said housing;
a non-toxic tube disposed coaxially in said fiberglass tube and spaced from said fiberglass tube, and defining an internal passageway for the flow of milk;
ceramic rings disposed between said fiberglass ring and said non-toxic tube;
isolation rings disposed between adjacent ones of said ceramic rings; and
an electrical power source for electrical excitation of said ceramic rings for effecting cavitation of milk in said assembly.
